(19) United States
(12) Patent Application Publication
(10) Pub. No.: US 2017/0321712 A1
(43) Pub. Date: Nov. 9, 2017

(54) SEAL DEVICE AND ROTARY MACHINE

(71) Applicants: MITSUBISHI HEAVY INDUSTRIES, LTD., Tokyo (JP); MITSUBISHI HEAVY INDUSTRIES COMPRESSOR CORPORATION, Tokyo (JP)

(72) Inventor: Takashi SATO, Tokyo (JP)

(73) Assignees: MITSUBISHI HEAVY INDUSTRIES, LTD., Tokyo (JP); MITSUBISHI HEAVY INDUSTRIES COMPRESSOR CORPORATION, Tokyo (JP)

(21) Appl. No.: 15/521,968

(22) PCT Filed: Oct. 20, 2015
(86) PCT No.: PCT/JP2015/079574

§ 371 Date: Apr. 26, 2017

(30) Foreign Application Priority Data
Oct. 29, 2014 (JP) 2014-220708

(51) Int. Cl. F04D 29/08; F16J 15/447; F04D 29/70

(52) U.S. Cl. CPC F04D 29/083; F04D 29/705; F16J 15/447

(57) ABSTRACT

A seal device has a seal main body. The seal main body includes a plurality of holes arranged to be recessed from a facing surface facing a rotor which rotates around an axis, and an ejection flow path which guides a fluid to bottom portions of the holes and ejects the fluid from the bottom portions.

### TECHNICAL FIELD

The present invention relates to a seal device and a rotary machine including the seal device.

Priority is claimed on Japanese Patent Application No. 2014-220708, filed Oct. 29, 2014, the content of which is incorporated herein by reference.

### BACKGROUND ART

Conventionally, a rotary machine such as a centrifugal compressor has been used when compressing a fluid or the like. As this type of rotary machine, for example, a centrifugal compressor described in Patent Literature 1 is known.

The centrifugal compressor has a plurality of impellers inside a casing. In the centrifugal compressor, a gas (fluid) suctioned from a suction port of a casing is compressed by rotation of a plurality of impellers and discharged from a discharge port of the casing. The gas compressed by each impeller is sealed by a mouthpiece seal of a mouthpiece portion of each impeller, an intermediate stage seal between the respective impellers, and a balance piston part seal provided in a final stage.

Seal devices such as labyrinth seals and damper seals are known as conventional seal structures. A damper seal is a seal structure in which a plurality of holes are provided on a surface of a seal stationary portion. The damper seal has a great gas leakage reduction effect and a great damping effect. Damper seals include hole pattern seals, honeycomb seals, and the like.

### CITATION LIST

### Patent Literature

### [Patent Literature 1]

Japanese Unexamined Patent Application, First Publication No. 2009-74423

### SUMMARY OF INVENTION

### Technical Problem

In a shaft system of the compressor, normally, the rotor is held by bearings installed at both ends. Unstable vibration of whirling of the shaft is excited by the fluid destabilization force acting in a circumferential direction. Conventionally, damping is imparted to the shaft system to reduce vibration of the shaft using a damper seal for the balance piston part seal.

A plurality of holes are formed in the damper seal. When the centrifugal compressor (rotary machine) having the damper seal is operated for a long period of time, there is a problem in that impurities, scales, metal powders, heavy compounds and the like (hereinafter referred to as impurities and the like) contained in the fluid are accumulated in the holes of the damper seal to block the holes.

The damper seal with the blocked holes functions only as an annular seal, and the damping performance is greatly degraded.

The present invention provides a seal device in which the holes are prevented from being blocked by impurities and the like, and a rotary machine in which the seal device is provided.

### Solution to Problem

A seal device according to a first aspect of the present invention has a seal main body, the seal main body including a plurality of holes arranged to be recessed from a facing surface facing a rotor which rotates around an axis, and an ejection flow path which guides a fluid to bottom portions of the holes and ejects the fluid from the bottom portions.

According to this configuration, by supplying the fluid from the ejection flow path and ejecting the fluid from the bottom portions of the holes, even if the holes are blocked with impurities and the like, the impurities and the like are removed by the power of the ejected fluid.

According to a second aspect of the present invention, in the seal device according to the first aspect, the ejection flow path has a distribution flow path which communicates with each of the plurality of holes, and a supply flow path which communicates with the distribution flow path, in a cross-section of a plane including the axis, a first inner surface of the distribution flow path on the axis side is parallel to the axis, and a second inner surface on an opposite side to the axis with respect to the first inner surface of the distribution flow path may be inclined from one side toward the other side along the axis to be separated from the first inner surface.

According to this configuration, the internal space of the distribution flow path is wider on the other side than on the one side. Due to the pressure loss of the fluid flowing through the distribution flow path, the fluid supplied from the ejection flow path easily flows to the other side from the one side of the distribution flow path.

Even when there is a pressure difference in the direction along the axis of the fluid disposed between the rotor and the seal main body, the seal main body is disposed with respect to the rotor so that the pressure of the fluid is higher on the other side of the distribution flow path. This makes it easier for the fluid to be ejected toward the rotor from the hole disposed on the higher pressure side of the fluid.

According to a third aspect of the present invention, in the seal device according to the first aspect or the second aspect, an inner diameter of a portion of the plurality of holes communicating with the ejection flow path may increase from one side toward the other side along the axis.

According to this configuration, it is possible to reduce the influence of pressure loss due to the distribution flow path, and to make the amount of fluid ejected from the bottom portion of the hole uniform, irrespective of the position in the axial direction.

A rotary machine according to a fourth aspect of the present invention includes the seal device according to any one of the first through third aspects, and the rotor.

According to this configuration, it is possible to prevent the holes of the seal device provided in the rotary machine from being blocked.

Further, in the rotary machine according to the fourth aspect, the rotary machine according to a fifth aspect of the present invention may have an on-off valve which switches between an open state in which the fluid flows through the ejection flow path and a closed state in which the fluid does not flow in the ejection flow path.

According to this configuration, it is possible to easily switch between a state in which a fluid is ejected from the holes and a state in which a fluid is not ejected from the holes by the on-off valve.

Further, in the fourth aspect or the fifth aspect of the present invention, the rotary machine according to a sixth aspect of the present invention may have a main body portion formed with a cleaning liquid flow path which supplies a cleaning liquid to the ejection flow path.

According to this configuration, impurities and the like can be effectively removed from the inside of the hole by cleaning the inside of the hole with the cleaning liquid.

### Advantageous Effects of Invention

According to the aspects of the present invention, it is possible to prevent the holes in the seal device from being blocked with impurities and the like.

### BRIEF DESCRIPTION OF DRAWINGS

FIG. 1 is a cross-sectional view of a rotary machine according to a first embodiment of the present invention.

FIG. 2 is a perspective view of a seal device in a rotary machine according to a first embodiment of the present invention.

FIG. 3 is a cross-sectional view of main parts of a seal device and a rotor of a rotary machine according to the first embodiment of the present invention.

FIG. 4 is a cross-sectional view of main parts of the seal device according to the first embodiment of the present invention.

FIG. 5 is a cross-sectional view of main parts of a seal device in a modified example of the first embodiment of the present invention.

FIG. 6 is a cross-sectional view of main parts of the rotary machine in the modified example of the first embodiment of the present invention.

FIG. 7 is a cross-sectional view of a rotary machine according to a second embodiment of the present invention.

FIG. 8 is a cross-sectional view of a rotary machine according to a third embodiment of the present invention.

### DESCRIPTION OF EMBODIMENTS

### First Embodiment

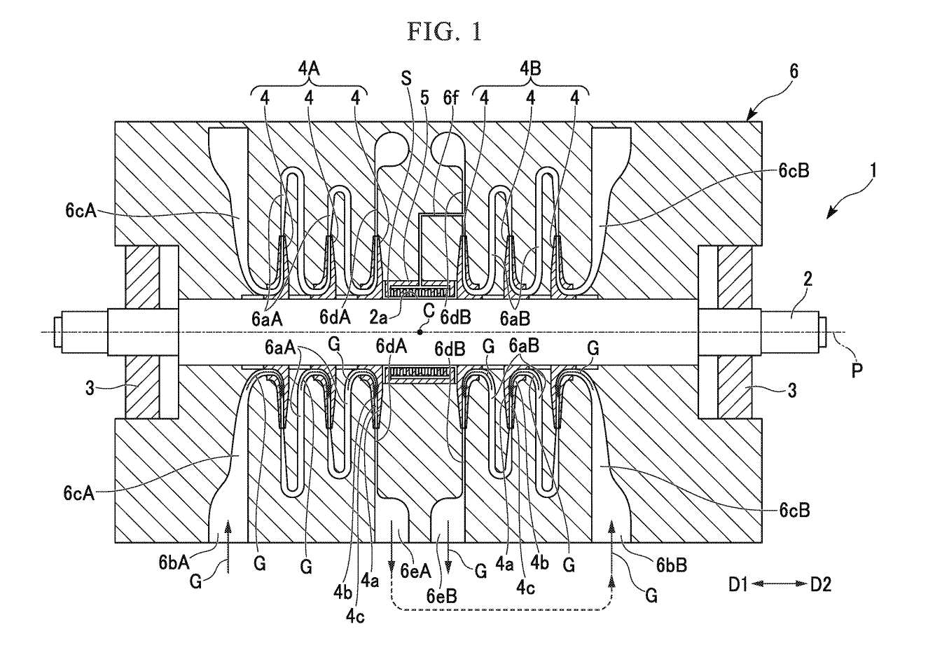

Hereinafter, a rotary machine 1 including a seal device 5 according to a first embodiment of the present invention will be described with reference to FIGS. 1 to 6. As illustrated in FIG. 1, the rotary machine 1 of the present embodiment is a multistage centrifugal compressor including a plurality of impellers 4.

The rotary machine 1 includes a rotor 2 centered on an axis P, a bearing 3 which rotatably supports the rotor 2 around the axis P, a plurality of impellers 4 attached to the rotor 2 to compress a process gas (fluid) G using centrifugal force, a seal device 5 arranged between the impellers 4 and provided along an outer circumferential surface 2a of the rotor 2, and a casing (main body portion) 6 which covers these elements from the outer circumferential side.

Further, a known liquid or gas can be used as the process gas G.

The rotor 2 has a columnar shape and extends in a direction in which the axis P extends (hereinafter referred to as a direction of the axis P). The rotor 2 is rotatably supported by bearings 3 at both ends in the direction of the axis P.

The bearings 3 are provided one by one at each end portion of the rotor 2 to rotatably support the rotor 2. The bearings 3 are both attached to the casing 6.

The impeller 4 compresses the process gas G using centrifugal force caused by the rotation. The impeller 4 is a so-called closed type impeller. The impeller 4 includes a disk 4a, a plurality of blades 4c, and a cover 4b.

The disks 4a of the plurality of impellers 4 are formed in a disc shape in which a diameter gradually increases to the radially outer side of the axis P toward a central position C of the rotor 2 in the direction of the axis P.

The blade 4c is formed to protrude from the disk 4a to the end portion side opposite to the central position C in the direction of the axis P. A plurality of blades 4c are formed at predetermined intervals in the circumferential direction of the axis P.

The cover 4b covers the plurality of blades 4c from the end portion side in the direction of the axis P. The cover 4b is formed in a disc shape facing the disk 4a.

A plurality of impellers 4 are attached to the rotor 2 between the bearings 3 arranged on both sides in the direction of the axis P. The impellers 4 constitute two pairs of three-stage impeller groups 4A and 4B in which the directions of the blades 4c face the sides opposite to each other in the direction of the axis P. In the three-stage impeller group 4A and the three-stage impeller group 4B, the pressure of the process gas G on the central position C side in the direction of the axis P is highest. That is, the process gas G flows in each of the three-stage impeller group 4A and the three-stage impeller group 4B while being compressed stepwise toward the central position C in the direction of the axis P.

The casing 6 supports the bearing 3 and covers each of the rotor 2, the impeller 4, and the seal device 5 from the outer circumferential side. The casing 6 is formed in a cylindrical shape.

A suction port 6bA is provided on one side D1 of the casing 6 in the direction of the axis P (on the side of the three-stage impeller group 4A with respect to the three-stage impeller group 4B in FIG. 1). The suction port 6bA is connected to a suction flow path 6cA formed in an annular shape. The suction flow path 6cA is connected to the flow path of the impeller 4 arranged on one side D1 of the three-stage impeller group 4A. That is, the process gas G flowing in from the suction port 6bA is introduced into the three-stage impeller group 4A via the suction flow path 6cA.

The casing 6 is equipped with casing flow paths 6aA and 6aB which connect the flow paths formed between the blades 4c of each impeller 4.

The casing 6 is equipped with a discharge port 6eA on the central position C side in the direction of the axis P. The discharge port 6eA is connected to a discharge flow path 6dA formed in an annular shape. The discharge flow path 6dA is connected to the flow path of the impeller 4 disposed on the other side D2 of the three-stage impeller group 4A (on the side of the three-stage impeller group 4B with respect to the three-stage impeller group 4A in FIG. 1). That is, the process gas G compressed by the impeller 4 disposed on the other side D2 of the three-stage impeller group 4A is discharged from the discharge port 6eA to the outer side of the casing 6 via the discharge flow path 6dA.

In the casing 6, one side D1 and the other side D2 in the direction of the axis P are symmetrically formed with the central position C as a boundary. On the other side D2 of the casing 6, a casing flow path 6aB, a suction port 6bB, a suction flow path 6cB, a discharge flow path 6dB, and a discharge port 6eB are formed. The three-stage impeller group 4B arranged on the other side D2 of the casing 6 further compresses the process gas G compressed by the three-stage impeller group 4A of the one side D1.

That is, on the other side D2 of the casing 6, the process gas G discharged from the discharge port 6eA is fed into the suction port 6bB. Thereafter, the process gas G flowing in from the suction port 6bB is supplied to the three-stage impeller group 4B via the suction flow path 6cB and compressed stepwise.

The process gas G compressed by the three-stage impeller group 4B is discharged from the discharge port 6eB to the outer side of the casing 6 via the discharge flow path 6dB.

In the casing 6, a guide flow path 6f having one end portion which communicates with the discharge flow path 6dB on one side D1 in the direction of the axis P of the three-stage impeller group 4B is formed.

As described above, the process gas G compressed in the three-stage impeller group 4A is introduced into the three-stage impeller group 4B and is further compressed to reach the vicinity of the central position C. Therefore, a pressure difference is generated between the three-stage impeller group 4A and the three-stage impeller group 4B. Specifically, the three-stage impeller group 4B has a higher pressure than the three-stage impeller group 4A. Further, in the vicinity of the central position C, a gap S is formed between the outer circumferential surface 2a of the rotor 2 and the inner circumferential surface of the casing 6. Therefore, the process gas G starts to flow toward a downstream side of one side D1 in the direction of the axis P in which the three-stage impeller group 4A is disposed, through the gap S, from the other side D2 as an upstream side in the direction of the axis P in which the three-stage impeller group 4B is disposed.

Therefore, in order to suppress the flow of the process gas G from the three-stage impeller group 4B as the upstream side to the three-stage impeller group 4A as the downstream side, the seal device 5 of this embodiment is provided in the vicinity of the central position C.

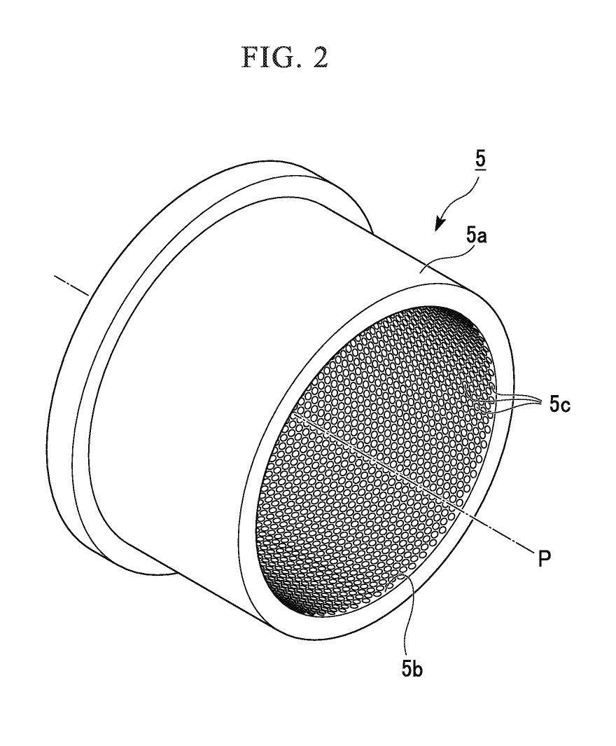

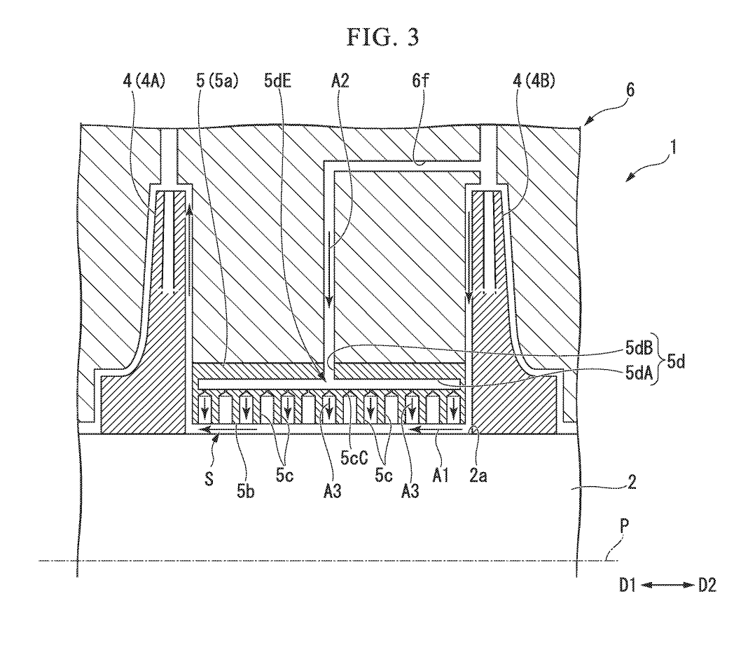

The seal device 5 is provided on the outer circumferential side of the rotor 2 to seal the flow of the process gas G between the three-stage impeller group 4A and the three-stage impeller group 4B. As illustrated in FIGS. 2 and 3, the seal device 5 has a seal main body 5a disposed to cover the outer circumferential surface 2a of the rotor 2.

The seal main body 5a is an annular member that is disposed to face the outer circumferential surface 2a of the rotor 2 with a predetermined gap S for rotating the rotor 2. A plurality of holes 5c are formed in the seal main body 5a. The holes 5c open on the inner circumferential surface (facing surface) 5b which faces the outer circumferential surface 2a of the rotor 2 in the seal main body 5a. The holes 5c are recessed from the opening toward the outer side of the axis P in the radial direction.

Further, in FIGS. 3 to 8, the holes 5c formed in the seal main body 5a are schematically illustrated in a reduced number.

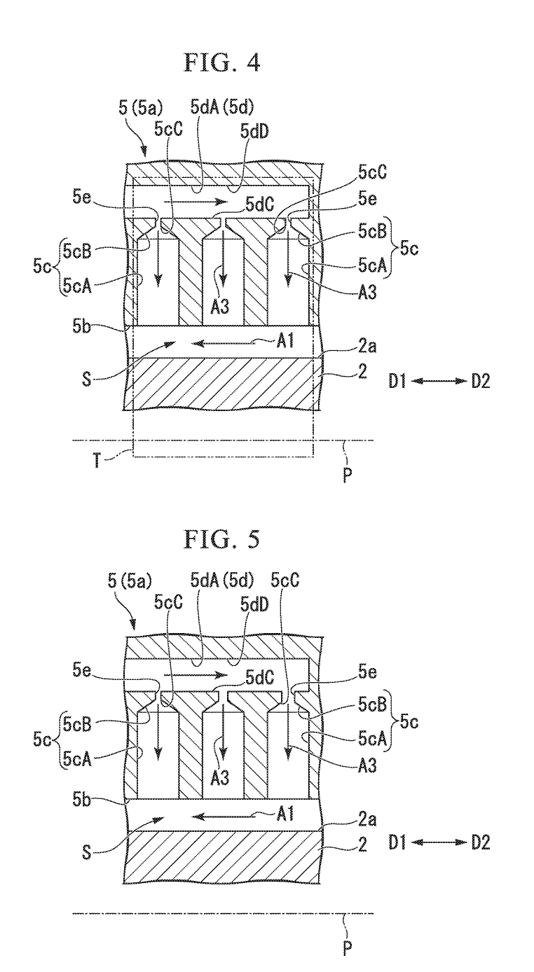

As illustrated in FIG. 4, the holes 5c have cylindrical hole main bodies 5cA extending from the opening of the inner circumferential surface 5b toward the outer side of the axis P in the radial direction, and conical reduced-diameter portions 5cB formed on the opposite side of the inner circumferential surface 5b with respect to the hole main bodies 5cA, that is, on the outer side of the hole main bodies 5cA in the radial direction.

The reduced-diameter portions 5cB are formed such that the inner diameters decrease as they separate outward in the radial direction from the hole main bodies 5cA. The hole main bodies 5cA communicate with the reduced-diameter portions 5cB. The portions farthest from the hole main bodies 5cA in the reduced-diameter portions 5cB are bottom portions 5cC of the holes 5c.

As described above, the plurality of holes 5c are arranged by being recessed from the inner circumferential surface 5b.

As illustrated in FIGS. 3 and 4, in the seal main body 5a, an ejection flow path 5d which communicates with each of the guide flow path 6f of the casing 6 and the plurality of holes 5c is formed. The ejection flow path 5d has a distribution flow path 5dA communicating with each of the plurality of holes 5c, and a supply flow path 5dB communicating with each of the distribution flow path 5dA and the guide flow path 6f of the casing 6. That is, the guide flow path 6f of the casing 6 is connected to the supply flow path 5dB of the ejection flow path 5d, and the supply flow path 5dB is connected to the distribution flow path 5dA. The supply flow path 5dB communicates with the central portion of the distribution flow path 5dA in the direction of the axis P.

In the cross-section on a virtual plane T including the axis P illustrated in FIG. 4, a first inner surface 5dC of the distribution flow path 5dA on the axis P side, and a second inner surface 5dD on the opposite side of the axis P to the first inner surface 5dC of the distribution flow path 5dA are both parallel to the axis P. That is, the first inner surface 5dC on the inner side of the distribution flow path 5dA in the radial direction and the second inner surface 5dD on the outer side of the distribution flow path 5dA in the radial direction are both parallel to the axis P.

The distribution flow path 5dA of the ejection flow path 5d and the bottom portions 5cC of the holes 5c communicate with each other via a cylindrical connection flow path (portions of the holes 5c communicating with the ejection flow path 5d) 5e. In this example, the inner diameter of the connection flow path 5e is constant, regardless of the position in the direction of the axis P.

Next, the operation of the seal device 5 configured as described above will be described.

In the rotary machine 1 as described above, some of the process gas G flows into the gap S between the outer circumferential surface 2a of the rotor 2 and the inner circumferential surface 5b of the seal main body 5a due to compression of the process gas G In the rotary machine 1, as described above, the pressure of the process gas G is higher on the three-stage impeller group 4B side than on the three-stage impeller group 4A side. Therefore, in the rotary machine 1, as illustrated in FIG. 3, the process gas G flows through the gap S from the other side D2 in the direction of the axis P toward the one side D1 as indicated by an arrow A1. At this time, some impurities and the like contained in the process gas G start to flow into the holes 5c.

Since the pressure of the process gas G is higher on the side of the three-stage impeller group 4B than on the side of the three-stage impeller group 4A, the process gas G flows toward the ejection flow path 5d through the guide flow path 6f of the casing 6 as indicated by an arrow A2. The process gas G flows by being guided to the supply flow path 5dB and the distribution flow path 5dA of the ejection flow path 5d. The process gas G flowing into the distribution flow path 5dA flows from a connection portion 5dE in which the supply flow path 5dB communicates with the distribution flow path 5dA toward one side D1 and the other side D2 in the direction of the axis P. The process gas G passes through the connection flow path 5e and is ejected from the bottom portion 5cC of each hole 5c as indicated by arrow A3 in FIGS. 3 and 4.

As the process gas G flows through the supply flow path 5dB, the distribution flow path 5dA, the connection flow path 5e, and the holes 5c, the pressure becomes lower than the pressure loss.

Due to the process gas G ejected from the bottom portion 5cC of each hole 5c, impurities and the like contained in the process gas G flowing in the gap S do not easily flow into the holes 5c. Even if the holes 5c are blocked with impurities and the like, the impurities and the like in the holes 5c are removed by the power of the process gas G ejected from the bottom portions 5cC.

The process gas G ejected from the bottom portion 5c C of each hole 5c merges with the process gas G flowing in the gap S and flows to the three-stage impeller group 4A side.

Therefore, in the seal device 5 and the rotary machine 1 of the embodiment, the process gas G flowing in the ejection flow path 5d is ejected from the bottom portions 5cC of the holes 5c. By ejecting the process gas G from the bottom portions 5cC of the holes 5c, impurities and the like are removed by the power of the ejected process gas G even if the holes 5c are blocked with impurities and the like. Therefore, it is possible to prevent the holes 5c of the seal device 5 from being blocked with impurities and the like.

In the present embodiment, as illustrated in FIG. 5, for example, on the other side D2 of the connection portion 5dE in which the supply flow path 5dB is connected to the distribution flow path 5dA, the inner diameter of the plurality of connection flow paths 5e may increase from one side D1 toward the other side D2 along the axis P. The pressure of the process gas G decreases due to the pressure loss of the distribution flow path 5dA toward the other side D2 from the connection portion 5dE, which makes it difficult for the process gas G to be ejected from the bottom portions 5cC of the holes 5c. By changing the inner diameters of the plurality of connection flow paths 5e as described above, it is possible to reduce the influence of the pressure loss caused by the distribution flow path 5dA, and it is possible to make the amount of the process gas G ejected from the bottom portions 5cC of the holes 5c uniform, regardless of the position in the direction of the axis P.

Similarly, on one side D1 of the connection portion 5dE, the inner diameter of the plurality of connection flow paths 5e may increase from the other side D2 toward the one side D1 along the axis P.

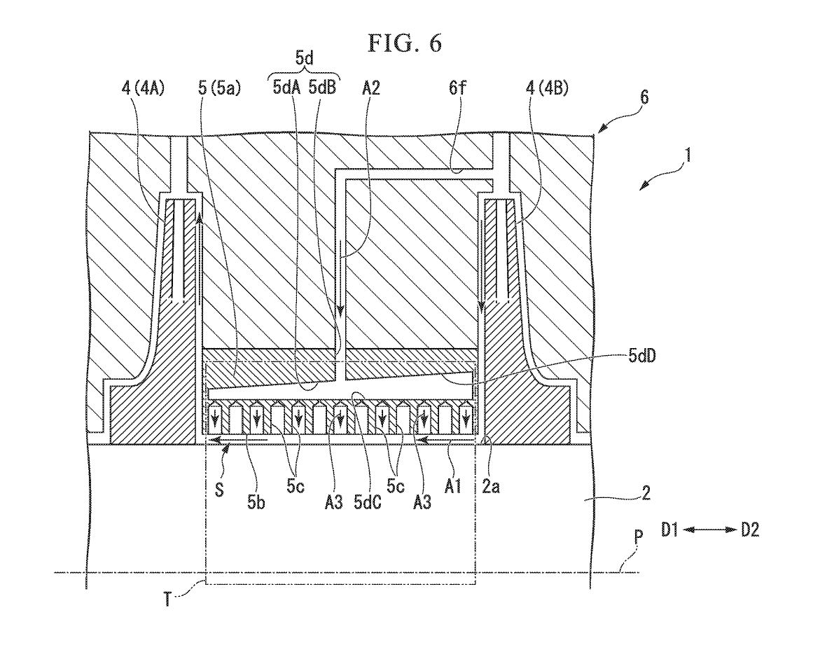

As illustrated in FIG. 6, in the cross-section of the plane T including the axis P, the second inner surface 5dD of the distribution flow path 5dA may be inclined to be separated from the first inner surface 5dC toward the other side D2 from the one side D1 along the axis P. In other words, a flow path cross-sectional area of the distribution flow path 5dA may increase from the one side D1 toward the other side D2 along the axis P. With such a configuration, the internal space of the distribution flow path 5dA is wider on the other side D2 than on the one side D1. Due to the pressure loss of the process gas G flowing in the distribution flow path 5dA, the process gas G supplied from the supply flow path 5dB easily flows toward the other side D2 from the one side D1 of the distribution flow path 5dA. Further, the pressure of the process gas G flowing through the gap S between the outer circumferential surface 2a of the rotor 2 and the inner circumferential surface 5b of the seal main body 5a is higher on the other side D2 than on the one side D1 in the direction of the axis P, due to the pressure loss.

As a result, the process gas G is also easily ejected toward the rotor 2 from the holes 5c arranged on the other side D2 in which the pressure of the process gas G is high in the gap S.

### Second Embodiment

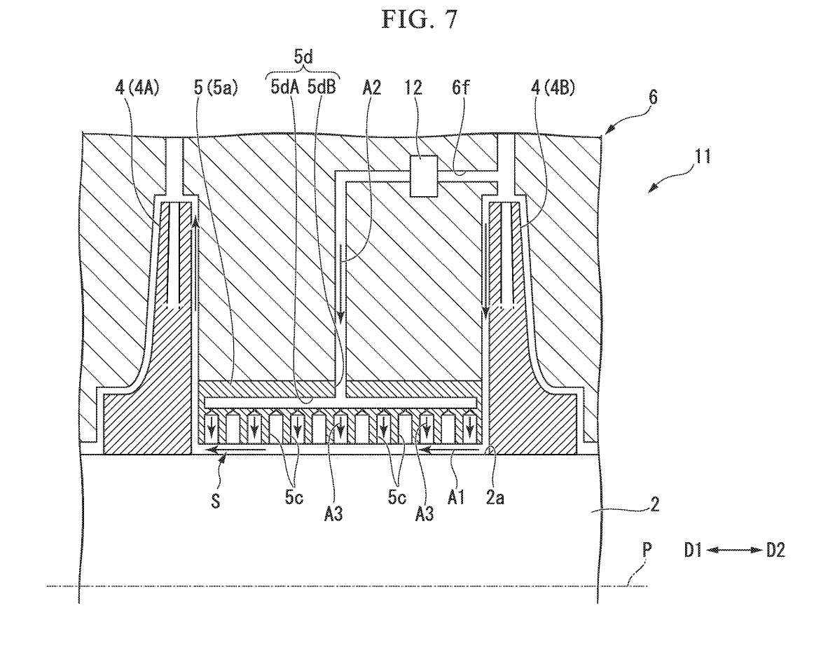

Next, a rotary machine 11 of a second embodiment will be described with reference to FIG. 7. In the second embodiment, the same constituent elements as those of the first embodiment are denoted by the same reference numerals, and a detailed description thereof will not be provided.

The rotary machine 11 of the second embodiment has an on-off valve 12 provided in a guide flow path 6f, in addition to the respective components of the rotary machine 1 of the first embodiment. As the on-off valve 12, a valve having a known configuration can be used. Although not illustrated, a valve main body built in the on-off valve 12 can be driven to open and close by a valve drive motor. As a result, the on-off valve 12 is switched between an open state in which the process gas G flows through the ejection flow path 5d and a closed state in which the process gas G does not flow through the ejection flow path 5d.

In the open state in which the process gas G flows through the ejection flow path 5d, the process gas G is ejected from the bottom portion 5cC of each hole 5c, and in the closed state in which the process gas G does not flow through the ejection flow path 5d, the process gas G is not ejected from each hole 5c.

Therefore, according to the rotary machine 11 of this embodiment, it is possible to prevent the holes 5c of the rotary machine 11 from being blocked by impurities and the like. Further, with the on-off valve 12, it is possible to easily switch between a state in which the process gas G is injected from the holes 5c and a state in which the process gas G is not injected from the holes 5c. It is possible to control the timing of ejecting the process gas G from the bottom portion 5cC of each hole 5c.

### Third Embodiment

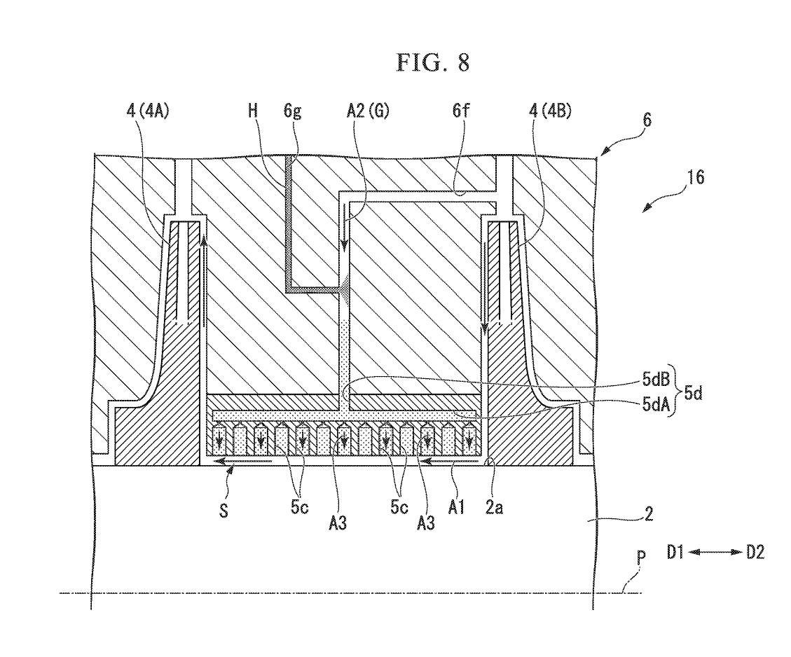

Next, a rotary machine 16 of a third embodiment will be described with reference to FIG. 8. In the third embodiment, the same constituent elements as those in the first embodiment are denoted by the same reference numerals, and a detailed description thereof will not be provided.

In the rotary machine 16 of the third embodiment, in addition to the respective components of the rotary machine 1 of the first embodiment, a cleaning liquid flow path 6g for supplying a cleaning liquid H to the ejection flow path 5d is formed in the casing 6. One end portion of the cleaning liquid flow path 6g communicates with the guide flow path 6f. A fluid supply pump (not illustrated) is provided at the other end portion of the cleaning liquid flow path 6g.

As the cleaning liquid H, a known liquid such as a hydrocarbon-based liquid and a fluorine-based liquid can be appropriately selected and used.

The cleaning liquid H supplied from the cleaning liquid flow path 6g is mixed with the process gas G at a connection portion between the guide flow path 6f and the cleaning liquid flow path 6g to become a mixed fluid and is supplied to each hole 5c. The cleaning liquid H in the mixed fluid ejected from the bottom portions 5cC of the holes 5c cleans the insides of the holes 5c. By injecting not only the process gas G but also the cleaning liquid H from the bottom portions 5cC of the holes 5c, impurities and the like accumulated in the holes 5c are removed.

Therefore, according to the rotary machine 16 of the embodiment, it is possible to prevent the holes 5c of the rotary machine 16 from being blocked by impurities and the like. Furthermore, by cleaning the insides of the holes 5c with the cleaning liquid H, it is possible to effectively remove impurities and the like from the insides of the holes 5c.

Although the embodiments of the present invention have been described in detail with reference to the drawings, specific configurations are not limited to these embodiments, and design changes and the like are also included within the scope that does not depart from the gist of the present invention.

For example, in the aforementioned first through third embodiments, the process gas G compressed by the three-stage impeller group 4B is injected from the bottom portion 5cC of each hole 5c. However, the process gas G compressed by another compression device may be ejected from the bottom portion 5cC of each hole 5c.

The fluid ejected from the bottom portion 5cC of each hole 5c may be a fluid other than the process gas G.

### INDUSTRIAL APPLICABILITY

According to an embodiment of the present invention, it is possible to prevent the holes in the seal device from being blocked with impurities and the like.

### REFERENCE SIGNS LIST

1, 11, 16 Rotary machine

2 Rotor

5 Seal device

5a Seal main body

5b Inner circumferential surface (facing surface)

5c Hole

5cC Bottom portion

5d Ejection flow path

5dA Distribution flow path

5dB Supply flow path

5dC First inner surface

5dD Second inner surface

6 Casing (main body portion)

6g Cleaning liquid flow path

12 On-off valve

D1 One side

D2 Other side

H Cleaning liquid

P Axis

1. A seal device comprising a seal main body, the seal main body including:
a plurality of holes arranged to be recessed from a facing surface facing a rotor which rotates around an axis; and
an ejection flow path which guides a fluid to bottom portions of the holes and ejects the fluid from the bottom portions.

2. The seal device according to claim 1, wherein the ejection flow path has
a distribution flow path which communicates with each of the plurality of holes, and
a supply flow path which communicates with the distribution flow path, and
in a cross-section of a plane including the axis,
a first inner surface of the distribution flow path on the axis side is parallel to the axis, and
a second inner surface on an opposite side of the axis with respect to the first inner surface of the distribution flow path is inclined from one side toward the other side along the axis to be separated from the first inner surface.

3. The seal device according to claim 1, wherein an inner diameter of a portion of the plurality of holes communicating with the ejection flow path increases from one side toward the other side along the axis.

4. A rotary machine comprising the seal device according to claim 1.

5. The rotary machine according to claim 4, further comprising:
an on-off valve which switches between an open state in which the fluid flows through the ejection flow path and a closed state in which the fluid does not flow through the ejection flow path.

6. The rotary machine according to claim 4, further comprising:
a main body portion formed with a cleaning liquid flow path which supplies a cleaning liquid to the ejection flow path.
